(19) United States
(12) Patent Application Publication
(10) Pub. No.: US 2011/0283738 A1
(43) Pub. Date: Nov. 24, 2011

(54) CRYSTALLIZED GLASS AND TOP PLATE FOR COOKING DEVICE COMPRISING SAME

(76) Inventors: Tai Fujisawa, Shiga (JP); Shingo Nakane, Shiga (JP)

(21) Appl. No.: 13/147,400

(22) PCT Filed: Feb. 3, 2010
(86) PCT No.: PCT/JP2010/051490

§ 371 Date: Aug. 2, 2011

(30) Foreign Application Priority Data
Feb. 5, 2009 (JP) 2009025398
Jan. 8, 2010 (JP) 2010002757
Jan. 8, 2010 (JP) 2010002761

(51) Int. Cl. C03C 10/14; C03C 10/12; C03C 3/083

(52) U.S. Cl. 65/33.8; 501/68; 65/33.7

(57) ABSTRACT

A crystallized glass comprises, in term of mass %, 55 to 73% of SiO₂, 17 to 25% of Al₂O₃, 2 to 5% of Li₂O, 4 to 5.5% of TiO₂, 0.05 to less than 0.2% of SnO₂, and 0.02 to 0.1% of V₂O₅. The crystallized glass has a ratio V₂O₅/(SnO₂+V₂O₅) of 0.2 to 0.4 and is substantially free of As₂O₃ and Sb₂O₃.

### TECHNICAL FIELD

The present invention relates to crystallized glass for used in a top plate for cooking device with an induction heating unit (IH), a halogen heater, or the like as a heat source.

### BACKGROUND ART

A top plate used in a cooking device with IH, a halogen heater, or the like as a heat source is required to be hardly broken (to have high mechanical strength and high thermal shock resistance), to have aesthetically pleasing external appearance, to be hardly corroded (to have high chemical resistance), to have a high transmittance of infrared light as a heat ray, and the like. As a material satisfying those characteristics, there is known low-expansion transparent crystallized glass containing a β-quartz solid solution (Li₂O—Al₂O₃-nSiO₂ (n≧2)) as a main crystal, which is used as a top plate for cooking device.

The low-expansion transparent crystallized glass is produced through a blending step of mixing various glass raw materials in a predetermined ratio, a melting step of melting the glass raw materials at high temperature of 1600 to 1900° C. to form a homogenized fluid, a forming step of forming the fluid into various shapes by various methods, an annealing step of removing distortion, and a crystallization step of precipitating fine crystals. The crystallization step includes a crystal nucleation step of precipitating fine crystals to be nuclei of crystals and a crystal growth step of growing the crystals.

The low-expansion transparent crystallized glass thus produced is generally transparent to visible light. Therefore, when the low-expansion transparent crystallized glass is used as a top plate as it is, an internal structure of a cooking device placed below the top plate is seen directly, which degrades external appearance. Therefore, the low-expansion transparent crystallized glass is used with visible light shielded sufficiently by coloring the crystallized glass with a coloring agent such as V₂O₅ (see, for example, Patent Document 1) or forming a light-shielding film on a surface of the crystallized glass (see, for example, Patent Document 2).

By the way, it is considered that the coloring of glass with a coloring agent such as V₂O₅ is caused (intensified) by an interaction between the coloring agent and As₂O₃ or Sb₂O₃ used as a fining agent. However, an environmental burden caused by As₂O₃ or Sb₂O₃ is large, and hence the use thereof has been being limited in recent years. If As₂O₃ or Sb₂O₃ is simply excluded from a conventional glass composition, coloring efficiency by a coloring agent tends to decrease. Although the effect of shielding visible light can also be enhanced by increasing the amount of a coloring agent, there is a problem that the infrared light transmittance decreases according to this method.

On the other hand, it is proposed that, for example, SnO₂ or the like is added as a component for enhancing the coloring efficiency of a coloring agent, instead of As₂O₂ or Sb₂O₂ (see, for example, Patent Document 3). According to this method, a top plate having a small environmental burden and being excellent in infrared light transparency and visible light shielding property can be obtained.

### CITATION LIST

### Patent Document

Patent Document 1: JP 03-9056 B
Patent Document 2: JP 2003-68435 A
Patent Document 3: JP 2004-523446 A

### SUMMARY OF INVENTION

### Technical Problem to be Solved by the Invention

Although the crystallized glass disclosed in Patent Document 3 has excellent infrared light transparency at the beginning of its use, there is a problem that the infrared light transmittance decreases during a long period of use. It is important that the high infrared light transmittance can be kept even after a long period of use, from the viewpoint of energy saving as well as cooking performance.

Further, the visible light transparency decreases after a long period of use, and hence there is a problem that only a heating portion is liable to be discolored, although cooking performance is not influenced directly.

Thus, a technical object of the present invention is to provide crystallized glass that has sufficient visible light shielding property and a high infrared light transmittance, these characteristics being unlikely to be impaired even after a long period of use, and a top plate for cooking device using such crystallized glass.

### Solution to Solve the Technical Problem

The inventors of the present invention have earnestly studied and, as a result, found that the above-mentioned problems can be solved by limiting the contents of V₂O₅ and Ti₂O, a blend ratio between V₂O₅ and SnO₂ and the like in crystallized glass within particular ranges and thus propose the finding as a first invention.

That is, the first invention relates to a crystallized glass, comprising, in term of mass %, 55 to 73% of SiO₂, 17 to 25% of Al₂O₃, 2 to 5% of Li₂O, 4 to 5.5% of TiO₂, 0.05 to less than 0.2% of SnO₂, and 0.02 to 0.1% of V₂O₅, wherein the crystallized glass has a ratio V₂O₅/(SnO₂+V₂O₅) of 0.2 to 0.4 and is substantially free of As₂O₃ and Sb₂O₃.

As described above, V₂O₅ has a function of decreasing an infrared light transmittance while acting as a coloring agent. In the present invention, the content of V₂O₅ is limited to a small amount as far as possible, namely to 0.02 to 0.1%, the blend ratio between SnO₂ and V₂O₅ is adjusted so that V₂O₅/(SnO₂+V₂O₅) is 0.2 to 0.4, and also the content of TiO₂ is adjusted to a relatively large amount, namely to 4 to 5.5%. As a result, the coloring efficiency of V₂O₅ can be enhanced so that the internal structure of a cooking device can be shielded sufficiently while a high infrared light transmittance is kept.

The crystallized glass of the present invention preferably further comprises 0.5% or less of Na₂O.

The crystallized glass of the present invention preferably further comprises 0 to 2.3% of ZrO₂.

In the crystallized glass of the present invention, the total amount of TiO₂ and ZrO₂ is preferable to being 4 to 6.5%.

The crystallized glass of the present invention preferably has a transmittance of 35% or less at a wavelength of 700 nm and a transmittance of 85% or more at a wavelength of 1150 nm when the crystallized glass has a thickness of 3 mm. In the present invention, the transmittance of crystallized glass is measured using a sample of crystallized glass whose surfaces are mirror polished.

Further, the inventors of the present invention have earnestly studied and, as a result, found that the decrease in transparency of visible light and infrared light during a long period of use is caused by the following phenomenon. That is, when crystallization in glass has not proceeded sufficiently, the crystallized glass is involved in an additional crystallization due to further heating, thereby the composition of a matrix glass phase of the crystallized glass changes. Then, the inventors have found that the above-mentioned problems can be solved by conducting heat treatment so that the crystallization in glass proceeds sufficiently, and thus propose the finding as a second invention.

That is, the second invention relates to a method of producing crystallized glass, including the steps of: (1) blending raw material powder so as to comprise, in terms of mass %, 55 to 73% of SiO₂, 17 to 25% of Al₂O₃, 2 to 5% of Li₂O, 2.6 to 5.5% of TiO₂, 0.01 to 0.3% of SnO₂, and 0.02 to 0.2% of V₂O₅, and being substantially free of As₂O₃ and Sb₂O₃; (2) melting the raw material powder to produce precursor glass; and (3) heat-treating the precursor glass in a temperature range of 765 to 785° C. for at least 10 minutes to form crystal nuclei in the precursor glass.

For crystallizing the precursor glass having the above-mentioned composition, a number of crystal nuclei can be precipitated by conducting heat treatment in a temperature range of 765 to 785° C. for at least 10 minutes. After that, crystals are allowed to grow, and thus the crystallization can proceed sufficiently within a short period of time. Therefore, in the crystallized glass produced according to the present invention, the crystallization hardly proceeds even when the crystallized glass is subjected to heating thereafter. As a result, a change in composition of the matrix glass phase involved in heating can be suppressed and a change in transparency characteristics in a visible light region and an infrared light region with the passage of time can be reduced.

The method of producing crystallized glass of the present invention preferably further includes the step of (4) heat-treating the precursor glass, in which the crystal nuclei have been formed, in a temperature range of 800 to 930° C. for at least 10 minutes to grow a crystal. This enables the crystallization to further proceed, and a change in transparency characteristics in the visible light region and the infrared region with the passage of time can be reduced further.

The crystallized glass produced by the method of producing crystallized glass of the present invention has, for example, an absorbance change ratio of 20% or less at a wavelength of 700 nm after heat treatment at 900° C. for 50 hours.

In the present invention described above, the coloring mechanism of crystallized glass is as follows.

V ions are present mainly in a trivalent to pentavalent state in glass, and it is presumed that the coloring of crystallized glass is caused by tetravalent V ions present in a matrix glass phase. Further, it is known that, when the tetravalent V ions are bonded to TiO₂ present in the matrix glass phase, the degree of coloring is further enhanced (visible light transmittance decreases). Thus, the coloring of the crystallized glass is largely influenced by the amounts of the tetravalent V ions and TiO₂ in the matrix glass phase.

On the other hand, it is known that the valence of the V ions changes due to the presence of Sn (in particular, the oxidation-reduction function of Sn ions). That is, it is considered that a blend ratio between V₂O₅ and SnO₂ influences the degree of coloring. In particular, by limiting the blend ratio between V₂O₅ and SnO₂ to the range in the first invention, the amount of tetravalent V ions increases and the effect of coloration of V₂O₅ can be exerted fully.

By the way, when the crystallized glass of the present invention is used, for example, as a top plate for cooking device for a long period of time, the crystallization further proceeds due to the heating during the use. When the crystallization further proceeds, the matrix glass composition changes, so that the concentrations of the tetravalent V ions and TiO₂, which do not contribute to the crystal composition, increase relatively in the matrix glass phase. As a result, a bonding state between the tetravalent V ions and TiO₂ changes, thereby the transmittance in the visible light region and the infrared region changes. In the crystallized glass of the present invention, TiO₂ is present in an excess amount with respect to the tetravalent V ions, and hence the bonding state between the tetravalent V ions and TiO₂ is hard to be changed even when the matrix glass composition changes after a long period of use, and the visible light transmittance is unlikely to change.

The crystallized glass of the present invention is crystallized glass containing a β-quartz solid solution as a main crystal, and has a property in which crystal transition from the β-quartz solid solution to a β-spodumene solid solution (Li₂O—Al₂O₃-nSiO₂ (n≧4)) may occur due to the heating during a long period of use, thereby white turbidity is generated. When white turbidity is generated in the crystallized glass, the external appearance thereof changes and the infrared light transmittance decreases due to scattering. It is known that As₂O₃ and Sb₂O₃ are components each having a function of largely promoting the crystal transition. The crystallized glass of the present invention is substantially free of As₂O₃ and Sb₂O₃, and hence has a feature in which the crystal transition is unlikely to occur and the transmittance change in the visible light region and the infrared light region during a long period of use is small. Further, it is known that V₂O₅ also has a function of promoting the crystal transition, and the above-mentioned effect can be enhanced by limiting the content of V₂O₅ to a small amount as in the first invention.

Further, the environmental burden of As₂O₃ or Sb₂O₃ is said to be large, and hence the use thereof has been limited in recent years. The crystallized glass of the present invention is substantially free of these components, and hence can reduce the environmental burden at a time of the disposal of the crystallized glass. The expression “substantially free of” in the present invention refers to a level at which these components are not intentionally added as components of the glass composition, in other words, these components come to be mixed in various glass raw materials as impurities, and specifically, refers to a content of 0.1% or less.

### DESCRIPTION OF EMBODIMENTS

Hereinafter, the reason why the composition of glass is limited as above in the first invention is described.

SiO₂ is a component that forms a skeleton of glass and forms a β-quartz solid solution. The content of SiO₂ is 55 to 73%, preferably 60 to 71%, more preferably 63 to 70%. When the content of SiO₂ decreases, the thermal expansion coefficient tends to increase, which makes it difficult to obtain crystallized glass excellent in thermal shock resistance. Further, the chemical resistance tends to decrease. On the other hand, when the content of SiO₂ increases, the meltability of glass is degraded and the viscosity of glass melt increases, and thus forming of glass tends to be difficult.

Al₂O₃ is a component that forms a skeleton of glass and forms a β-quartz solid solution. The content of Al₂O₃ is 17 to 25%, preferably 17.5 to 24%, more preferably 18 to 22%. When the content of Al₂O₃ decreases, the thermal expansion coefficient tends to increase, which makes it difficult to obtain crystallized glass excellent in thermal shock resistance. Further, the chemical resistance tends to decrease. On the other hand, when the content of Al₂O₃ increases, the meltability of glass is degraded and the viscosity of glass melt increases, and thus forming of glass tends to be difficult. Further, the glass tends to be devitrified due to precipitation of mullite crystals, and cracks are liable to occur in glass from the devitrified portion, which makes forming of glass difficult.

Li₂O is a component that forms a β-quartz solid solution and is also a component that has a large effect on crystallinity and decreases the viscosity of glass to enhance the meltability and formability. The content of Li₂O is 2 to 5%, preferably 2.3 to 4.7%, more preferably 2.5 to 4.5%. When the content of Li₂O decreases, glass tends to be devitrified due to precipitation of mullite crystals, and cracks are liable to occur in glass from the devitrified portion, which makes forming of glass difficult.

Further, when glass is crystallized, a β-quartz solid solution crystal becomes hard to be precipitated, and crystallized glass excellent in thermal shock resistance becomes hard to be obtained. Further, the meltability of glass tends to decrease and the viscosity of glass melt tends to increase, which makes forming of glass difficult. On the other hand, when the content of Li₂O increases, the crystallinity becomes too strong, and a coarse crystal is liable to be precipitated in a crystallization step. As a result, transparent crystallized glass is hard to be obtained due to white turbidity, or the resultant glass is liable to be broken, which makes forming of glass difficult.

TiO₂ is a component that forms crystal nuclei for precipitating crystals in a crystallization step, and has a function of enhancing the coloration of tetravalent V ions. The content of TiO₂ is 4 to 5.5%, preferably 4.1 to 5.3%, more preferably 4.2 to 5.1%. When the content of TiO₂ decreases, the amount of TiO₂ that is not used as crystal nuclei and remains in a matrix glass phase becomes small. Therefore, TiO₂ is hard to be bonded to the tetravalent V ions, and the efficiency of the coloration tends to decrease. Further, proceeding with crystallization during a long period of use, as described above, the concentrations of the tetravalent V ions and TiO₂ in the glass matrix increase, and the bonding state therebetween changes. Therefore, the degree of coloring tends to change unfavorably (in particular, the color tends to become deep). Further, a sufficient number of crystal nuclei are not formed, and hence the grain diameter of a crystal growing from each crystal nucleus becomes large (coarse crystal) to generate white turbidity, so that transparent crystallized glass is hard to be obtained. On the other hand, when the content of TiO₂ increases, glass tends to be devitrified during the step from melting to forming, and thus the glass becomes liable to be broken, which makes forming of glass difficult.

SnO₂ is a component that increases the tetravalent V ions as a coloring component to enhance the coloration. The content of SnO₂ is 0.05 to less than 0.2%, preferably 0.06 to 0.18%, more preferably 0.07 to 0.15%. When the content of SnO₂ decreases, the tetravalent V ions are not generated efficiently, and hence the effect of coloration is hard to be enhanced. When the content of SnO₂ increases, glass tends to be devitrified during melting and forming, which makes forming of glass difficult. Further, a color tone tends to change due to slight differences in melting conditions and crystallization conditions even with the same composition.

V₂O₅ is a coloring component. The content of V₂O₅ is 0.02 to 0.1%, preferably 0.02 to 0.05%. When the content of V₂O₅ decreases, the coloring becomes weak, so that visible light can not be shielded sufficiently. On the other hand, when the content of V₂O₅ increases, the transmittance of infrared light tends to decrease. Further, crystal transition from a β-quartz solid solution to a β-spodumene solid solution becomes liable to be occurred, which may cause white turbidity.

Regarding the blend ratio between V₂O₅ and SnO₂2, the mass ratio of V₂O₅/(SnO₂+V₂O₅) is 0.2 to 0.4, preferably 0.25 to 0.35. If the blend ratio between V₂O₅ and SnO₂ becomes larger or smaller than this range, a high effect of coloration is hard to be obtained because the amount of tetravalent V ions decreases.

Further, in addition to the above-mentioned components, various components can be added to the crystallized glass of the present invention in a range not impairing the required characteristics.

MgO is a component that forms a solid solution in a β-quartz solid solution crystal in place of Li₂O. The content of MgO is 0 to 1.5%, preferably 1 to 1.4%, more preferably 0.1 to 1.2%. When the content of MgO increases, the resultant glass tends to be devitrified because the crystallization becomes too strong. As a result, the glass is liable to be broken to make forming of glass difficult.

ZnO is a component that forms a solid solution in a β-quartz solid solution crystal in a similar manner to MgO. The content of ZnO is 0 to 1.5%, preferably 0 to 1.4%, more preferably 0.1 to 1.2%. When the content of ZnO increases, the crystallinity tends to become too strong. Therefore, when forming is performed with gradual cooling, glass is devitrified to be liable to be broken, which is unsuitable for forming, for example, by a float method.

ZrO₂ is a component that forms crystal nuclei for precipitating crystals in a crystallization step in a similar manner to TiO₂. The content of ZrO₂ is 0 to 2.3%, preferably 0 to 2.1%, more preferably 0.1 to 1.8%. When the content of ZrO₂ increases, glass tends to be devitrified during melting and forming steps, which makes forming of glass difficult.

P₂O₅ is a component that promotes the phase separation of glass. Since crystal nucleus is likely to be generated in a region where glass causes phase separation, P₂O₅ has a function of promoting the formation of crystal nucleus. The content of P₂O₅ is 0 to 2%, preferably 0.1 to 1%. When the content of P₂O₅ increases, the glass causes phase separation during the melting step. Therefore, the glass having a desired composition is hard to be obtained, and the resultant glass tends to be opaque.

The total amount of TiO₂ and ZrO₂ is 4 to 6.5%, preferably 4.5 to 6%. When the total amount of these components increases, glass tends to be devitrified during melting and forming steps, which makes forming of glass difficult. On the other hand, when the total amount of these components is too small, crystal nuclei are not formed sufficiently, and hence the crystal is liable to become coarse. As a result, transparent crystallized glass is hard to be obtained due to white turbidity.

Na₂O is a component that decreases the viscosity of glass to enhance the meltability and formability of glass. The content of Na₂O is 0.5% or less, preferably 0.3% or less, more preferably 0.2% or less. When the content of Na₂O is too large, the crystal transition from a β-quartz solid solution to a β-spodumene solid solution is promoted, and hence white turbidity is liable to occur due to coarse crystals. Further, the thermal expansion coefficient tends to increase, which makes it difficult to obtain crystallized glass excellent in thermal shock resistance.

In order to decrease the viscosity of glass to enhance the meltability and formability thereof, K₂O, CaO, SrO, and BaO can be added in a total amount of up to 5%. CaO, SrO, and BaO are each a component that cause denitrification when glass is melted. Therefore, it is preferable that the total amount of these components be 2% or less. Further, CaO has a function of promoting the crystal transition from a β-quartz solid solution to a β-spodumene solid solution, and hence it is preferred to refrain from using CaO as far as possible.

As a fining agent, SO₂ and Cl may be added alone or in combination, if required. The total amount of these components is preferably 0.5% or less. As₂O₃ and Sb₂O₃ are also fining components, however, these components are considered to have large environmental burden, and hence it is important to be substantially free of these components.

Colored transition metal elements (for example, Cr, Mn, Fe, Co, Ni, Cu, Mo, and Cd) that are not described above may absorb infrared light or may cause the loss of a reducting ability of Sn ions (the colored transition metal elements react with Sn ions to inhibit a reaction between V ions and the Sn ions). Therefore, it is preferred to refrain from containing these elements as far as possible.

The crystallized glass of the present invention, when having a thickness of 3 mm, has a transmittance at a wavelength of 700 nm of preferably 35% or less, more preferably 30% or less. This can shield the internal structure of a cooking device sufficiently. On the other hand, when a temperature, a thermal power, or the like are displayed using an LED or the like, the transmittance at a wavelength of 700 nm at a thickness of 3 mm is preferably 15% or more, 18% or more, still more preferably 20% or more. Thus, when the crystallized glass is used for a top plate of cooking device with IH or the like, the display by an LED or the like can be recognized sufficiently through the crystallized glass.

Further, as another indication, the crystallized glass of the present invention preferably has an absorbance change ratio of 10% or less at a wavelength of 700 nm after heat treatment at 900° C. for 50 hours. An absorbance change ratio is calculated as follows.

Absorbance=log₁₀(transmittance (%)/100)

Absorbance change ratio=(absorbance after heat treatment−absorbance before heat treatment)/absorbance before heat treatment×100(%)

Further, the crystallized glass of the present invention, when having a thickness of 3 mm, has a transmittance of preferably 85%, more preferably 86% or more at a wavelength of 1150 nm, in order to transmit a heat ray (infrared light) efficiently.

It is preferred that, even when the crystallized glass of the present invention is used for such application as a top plate for cooking device for a long period of time, the high infrared light transmittance be not impaired, and also the visible light transmittance be hard to be changed. Specifically, it is preferred that the crystallized glass of the present invention has, in an acceleration test, a change amount of a transmittance of 5% or less, 3% or less, 2% or less, 1.5% or less, particularly 1% or less, at a wavelength of 1150 nm after heat treat treatment at 900° C. for 50 hours. Further, in the above acceleration test, it is preferred that a change amount of a transmittance at a wavelength of 700 nm be 5% or less, 3% or less, 2% or less, 1.5% or less, particularly 1% or less.

The thermal expansion coefficient of the crystallized glass of the present invention in a temperature range of 30 to 750° is preferably −10 to 30×10⁻⁷/° C., more preferably −10 to 20×10⁻⁷/° C. When the thermal expansion coefficient is within this range, glass excellent in thermal shock resistance is obtained. In the present invention, the thermal expansion coefficient refers to a value measured by a dilatometer.

The crystallized glass of the present invention can be produced as follows.

First, various glass raw materials are blended so as to obtain the above-mentioned composition. If required, MgO or ZnO, which forms a solid solution in a crystal by replacing a part of Li₂O, a component for enhancing the meltability and formability of glass, a fining agent, or the like may be added.

Next, the blended glass raw materials are melted at a temperature of 1600 to 1900° C. and formed to obtain crystallizable glass. As a forming method, various forming methods such as a blow method, a press method, a roll-out method, and a float method are applicable.

After the crystallizable glass is annealed, the crystallizable glass is heat-treated at 700 to 800° C. for 10 minutes to 10 hours to form crystal nuclei. Then, the resultant is heat-treated at 800 to 900° C. for 10 minutes to 10 hours to grow β-quartz solid solution crystals to obtain crystallized glass.

The crystallized glass thus produced may be subjected to post-processing such as cutting, polishing, bending, and reheat pressing, and a surface thereof may be subjected to painting, film coating, or the like.

### Example 1

Tables 1 to 3 show examples (Sample Nos. 1 to 7 and 12) and comparative examples (Sample Nos. 8 to 11, 13, and 14) with respect to the first invention.

TABLE 1

| [Mass %] | | | No. 1 | No. 2 | No. 3 | No. 4 | No. 5 |
|---|---|---|---|---|---|---|---|
| SiO₂ | | | 68.86 | 68.97 | 67.93 | 68.58 | 67 |
| Al₂O₃ | | | 20 | 20 | 21 | 19 | 20.5 |
| Li₂O | | | 4.1 | 4.1 | 3.8 | 3.7 | 4.3 |
| Na₂O | | | 0.5 | 0.2 | 0.4 | 0.1 | 0.2 |
| K₂O | | | 0.3 | 0.5 | 0.3 | 0.5 | 0.8 |
| MgO | | | 0.8 | 0.8 | 1 | 0.7 | — |
| ZnO | | | 0.5 | 0.5 | 0.6 | 1.1 | 0.7 |
| TiO₂ | | | 4.8 | 4.8 | 4.3 | 5 | 4.5 |
| ZrO₂ | | | — | — | 0.5 | 1 | 0.8 |
| P₂O₅ | | | — | — | — | — | 1 |
| SnO₂ | | | 0.1 | 0.08 | 0.13 | 0.09 | 0.16 |
| V₂O₅ | | | 0.04 | 0.05 | 0.04 | 0.03 | 0.04 |
| Cl | | | — | — | — | 0.2 | — |
| Total | | | 100 | 100 | 100 | 100 | 100 |
| V₂O₅/(V₂O₅ + SnO₂) | | | 0.29 | 0.38 | 0.24 | 0.25 | 0.20 |
| TiO₂ + ZrO₂ | | | 4.8 | 4.8 | 4.8 | 6 | 5.3 |
| Transmittance | After | λ = 700 nm | 26.2 | 23.1 | 27.1 | 28.6 | 28.0 |
| (%) | crystallization | λ = 1150 nm | 87.6 | 86.1 | 86.9 | 87.4 | 86.9 |
| | After heat | λ = 700 nm | 25.3 | 22.8 | 26.3 | 28.1 | 27.2 |
| | treatment | λ = 1150 nm | 87.3 | 85.2 | 86.5 | 87.5 | 86.5 |

| | | | | | |
|---|---|---|---|---|---|
| Absorbance change ratio (%) | 3 | 1 | 2 | 1 | 2 |
| (λ = 700 nm) | | | | | |
| Devitrification | ∘ | ∘ | ∘ | ∘ | ∘ |

TABLE 2

| [Mass %] | | | No. 6 | No. 7 | No. 8 | No. 9 | No. 10 |
|---|---|---|---|---|---|---|---|
| SiO₂ | | | 66.96 | 69.67 | 68.86 | 67.57 | 67.67 |
| Al₂O₃ | | | 21.5 | 19.3 | 20.0 | 21.4 | 19.3 |
| Li₂O | | | 3.6 | 3.7 | 4.0 | 3.9 | 3.7 |
| Na₂O | | | 0.1 | 0.5 | 0.4 | 0.3 | 0.5 |
| K₂O | | | — | 0.4 | 0.4 | 0.6 | 0.4 |
| MgO | | | 0.4 | 0.2 | 0.7 | 0.4 | 0.2 |
| ZnO | | | 1.5 | 1 | 0.7 | 0.8 | 1.0 |
| TiO₂ | | | 4.8 | 4 | 3.8 | 4.0 | 6.0 |
| ZrO₂ | | | 1 | 0.7 | 1.0 | — | 0.7 |
| P₂O₅ | | | — | — | — | — | — |
| SnO₂ | | | 0.1 | 0.15 | 0.1 | 1.0 | 0.15 |
| V₂O₅ | | | 0.04 | 0.08 | 0.04 | 0.03 | 0.08 |
| Cl | | | — | 0.3 | — | — | 0.3 |
| Total | | | 100 | 100 | 100 | 100 | 100 |
| V₂O₅/(V₂O₅ + SnO₂) | | | 0.29 | 0.35 | 0.29 | 0.03 | 0.35 |
| TiO₂ + ZrO₂ | | | 5.8 | 4.7 | 4.8 | 4 | 6.7 |
| Transmittance | After | λ = 700 nm | 27.0 | 21.8 | 27.1 | 65.2 | 18.4 |
| (%) | crystallization | λ = 1150 nm | 86.1 | 87.7 | 86.5 | 89.3 | 82.4 |
| | After heat | λ = 700 nm | 26.7 | 21.2 | 14.5 | 60.4 | 16.3 |
| | treatment | λ = 1150 nm | 85.4 | 86.0 | 69.4 | 88.6 | 81.7 |

| | | | | | |
|---|---|---|---|---|---|
| Absorbance change ratio (%) | 1 | 2 | 48 | 18 | 7 |
| (λ = 700 nm) | | | | | |
| Devitrification | ∘ | ∘ | ∘ | x | x |

TABLE 3

| | | | [Mass %] | | | |
|---|---|---|---|---|---|---|
| | | | No. | No. | No. | No. |
| | | | 11 | 12 | 13 | 14 |
| SiO₂ | | | 67.82 | 67.73 | 67.31 | 65.5 |
| Al₂O₃ | | | 20.5 | 21.5 | 21.4 | 21.9 |
| Li₂O | | | 4.3 | 4.0 | 3.8 | 4.4 |
| Na₂O | | | 0.3 | 0.7 | 0.6 | 0.3 |
| K₂O | | | 0.3 | 0.1 | 0.1 | 0.3 |
| MgO | | | 0.6 | 0.7 | 1 | 0.8 |
| ZnO | | | 0.2 | 0.2 | 1.6 | 1.7 |
| TiO₂ | | | 4.2 | 4.5 | 2.4 | 4.3 |
| ZrO₂ | | | 1.2 | 0.2 | 1.5 | — |
| P₂O₅ | | | 0.5 | 0.2 | — | — |
| SnO₂ | | | 0.04 | 0.12 | 0.22 | — |
| V₂O₅ | | | 0.04 | 0.05 | 0.07 | 0.1 |
| As₂O₃ | | | — | — | — | 0.7 |
| Total | | | 100 | 100 | 100 | 100 |
| V₂O₅/(V₂O₅ + SnO₂) | | | 0.50 | 0.29 | 0.24 | 1.0 |
| TiO₂ + ZrO₂ | | | 5.4 | 4.7 | 3.9 | 4.3 |
| Transmit- | After | λ = 700 nm | 70.5 | 25.4 | 33.5 | 20.6 |
| tance (%) | crystal- | λ = 1150 nm | 87.1 | 86.5 | 84.2 | 79.2 |
| | lization | | | | | |
| | After heat | λ = 700 nm | 67.2 | 23.1 | 12.2 | 5.7 |
| | treatment | λ = 1150 nm | 86.4 | 83.2 | 65.4 | 61.3 |

| | | | | |
|---|---|---|---|---|
| Absorbance change ratio (%) | 12 | 6 | 92 | 81 |
| (λ = 700 nm) | | | | |
| Devitrification | ∘ | ∘ | ∘ | ∘ |

Glass raw materials were blended so as to obtain the compositions described in Tables 1 to 3, and melted at 1600° C. for 20 hours, further at 1700° C. for 4 hours, using a platinum crucible. Two spacers each with a thickness of 5 mm were placed on a carbon plate, and molten glass was poured between the spacers and formed into a plate shape uniformly with a roller.

The resultant plate shaped sample was placed in an electric furnace kept at 700° C. and held for 30 minutes. After that, a power source was turned off to cool the sample to room temperature in the furnace over 10 hours or more.

Then, the cooled sample was crystallized in the electric furnace to obtain crystallized glass. The profile thereof was set as follows: nucleus formation was performed at 770° C. for 3 hours, and crystal growth was performed at 880° C. for one hour.

Each crystallized glass was evaluated for its transmittance in each of visible and infrared regions and devitrification property.

Each crystallized glass was processed into a sample having a thickness of 3 mm with both surfaces which are mirror polished, and the transmittance thereof was measured at 700 nm and 1150 nm, using a spectrophotometer (manufactured by Jasco Corporation, V-760). The measurement conditions were as follows: a measurement range of 1500 to 380 nm and a scan speed of 200 nm/min. Further, the samples subjected to heat treatment (acceleration test) at 900° C. for 50 hours were also measured for transmittance similarly.

Devitrification property was evaluated by placing each sample on a platinum foil in an electric furnace set to 1350° C., keeping the sample in that state for 24 hours, and determining whether or not devitrification occurred. If the devitrification was not observed, the evaluation was made as “o”, and if the devitrification was observed, the evaluation was made as “x”.

As is apparent from Tables 1 to 3, it is understood that each of Sample Nos. 1 to 7 and 12 as examples is capable of shielding light in the visible light region sufficiently, has a high infrared light transmittance, and has a small transmittance change in each of the visible and infrared light regions even in an acceleration test in which a long-term use is assumed.

On the other hand, in Sample No. 8 as a comparative example, a change width of a transmittance in each of the visible and infrared light regions after the acceleration test was large. In each of Sample Nos. 9 and 11 as comparative examples, a transmittance in the visible light region after the crystallization was not sufficiently low. Further, in Sample No. 9 as a comparative example, devitrification was observed. In Sample No. 10 as a comparative example, the transmittance in the infrared light region after the crystallization was not sufficiently high, and devitrification was observed. Further, in each of Sample Nos. 13 and 14 as comparative examples, a change in a transmittance (absorbance) before and after the heat treatment was large.

Next, the second invention is described.

A production method of the present invention includes, first, blending raw material powder so as to comprise, in terms of mass %, 55 to 73% of SiO₂, 17 to 25% of Al₂O₃, 2 to 5% of Li₂O, 2.6 to 5.5% of TiO₂, 0.01 to 0.3% of SnO₂, and 0.02 to 0.2% of V₂O₅, and being free of As₂O₃ and Sb₂O₃. The reason why the composition is limited as above is described below.

Regarding SiO₂, Al₂O₃, and Li₂O, the reason for the limitation of the contents thereof and the preferred range of the contents are the same as those in the first invention described above, and hence the descriptions thereof are omitted.

TiO₂ is a component that forms crystal nuclei for precipitating crystals in a crystallization step, and has a function of enhancing the coloration of tetravalent V ions. The content of TiO₂ is 2.6 to 6.5%, preferably 2.6 to 5%, more preferably 2.8 to 4.8%, still more preferably 3 to 4.5%. When the content of TiO₂ decreases, the amount of TiO₂ that is not used as crystal nuclei and remains in a matrix glass phase becomes small. Therefore, TiO₂ is hard to be bonded to the tetravalent V ions, and the efficiency of the coloration tends to decrease. Further, proceeding with crystallization during a long period of use, as described above, the concentrations of the tetravalent V ions and TiO₂ in the glass matrix increase, and the bonding state therebetween changes. Therefore, the degree of coloring tends to change unreasonably (in particular, the color tends to become deep). Further, a sufficient number of crystal nuclei are not formed, and hence the grain diameter of a crystal growing from each crystal nucleus becomes large (coarse crystal) to generate white turbidity, so that transparent crystallized glass is hard to be obtained. On the other hand, when the content of TiO₂ increases, glass tends to be devitrified during the step from melting to forming, and thus the glass becomes liable to be broken, which makes forming of glass difficult.

SnO₂ is a component that increases the tetravalent V ions as a coloring component to enhance the coloration. The content of SnO₂ is 0.01 to 0.3%, preferably 0.03 to 0.25%, more preferably 0.05 to 0.23%. When the content of SnO₂ decreases, the tetravalent V ions are not generated efficiently, and hence the effect of the coloration is hard to be enhanced. When the content of SnO₂ increases, glass tends to be devitrified during melting and forming, which makes forming of glass difficult. Further, a color tone tends to change easily due to slight differences in melting conditions and crystallization conditions even with the same composition.

V₂O₅ is a coloring component. The content of V₂O₅ is 0.02 to 0.2%, preferably 0.03 to 0.15%. When the content of V₂O₅ decreases, the coloring becomes weak, so that visible light cannot be shielded sufficiently. On the other hand, when the content of V₂O₅ increases, the transmittance of infrared light tends to decrease. Further, crystal transition from a β-quartz solid solution to a β-spodumene solid solution becomes liable to be occurred, which may cause white turbidity.

As₂O₃ and Sb₂O₃ are not substantially contained for the above-mentioned reasons.

Further, in addition to the above-mentioned components, various components can be added in a range not impairing the required characteristics. For example, MgO, ZnO, ZrO₂, P₂O₅, Na₂O, K₂O, CaO, SrO, BaO, SO₂, and Cl may be added in the same content ranges for the same reasons described regarding the first invention in the foregoing. In the case where ZrO₂ is added, the total amount of TiO₂ and ZrO₂ is 3.8 to 6.5%, preferably 4.2 to 6%. When the total amount of these components increases, glass tends to be devitrified during melting and forming steps, which makes forming of the glass difficult. On the other hand, when the total amount of these components is too small, crystal nuclei are not formed sufficiently. Therefore, the crystal is liable to become coarse. As a result, transparent crystallized glass is hard to be obtained due to white turbidity. Further, it is preferred to minimize the contents of colored transition metal elements (for example, Cr, Mn, Fe, Co, Ni, Cu, Mo, and Cd) for the above-mentioned reasons.

The raw material powder blended as described above is melted to obtain crystallizable precursor glass. Although a melting temperature is not particularly limited, the melting temperature is preferably, for example, 1600 to 1900° C. so as to allow vitrification to proceed sufficiently. As a forming method of molten glass, various forming methods such as a blow method, a press method, a roll-out method, and a float method are applicable. The formed precursor glass is subjected to annealing, if required.

Next, the precursor glass is heat-treated in a temperature range of 765 to 785° C. for at least 10 minutes. In the heat treatment step, crystal nuclei can be precipitated. When the heat treatment temperature is out of the range, a sufficient number of crystal nuclei are hard to be formed. The temperature range of 765 to 785° C. is a range in which crystal nuclei are most likely to be formed, and thus crystal nuclei can be formed sufficiently. When the heat treatment time is shorter than 10 minutes, the color of glass immediately after the crystallization is pale, and white turbidity tends to occur. On the other hand, even when the heat treatment time is too long, the amount of crystal nuclei to be formed is unlikely to become large, which is rather disadvantageous for productivity and energy aspects. Therefore, the upper limit of the heat treatment time is preferably 10 hours or less, 3 hours or less, particularly 2 hours or less.

The precursor glass in which the crystal nuclei have been formed is further heat-treated to grow crystals, and thus desired crystallized glass is obtained. Here, the heat treatment is conducted at 800 to 930° C., preferably 850 to 920° C., more preferably 870 to 890° C. for at least 10 minutes in order to promote the crystallization sufficiently. When the heat treatment time is shorter than 10 minutes, the color of glass immediately after the crystallization is pale, and white turbidity tends to occur. On the other hand, even when the heat treatment time is too long, the amount of crystal nuclei to be formed is unlikely to become large, which is rather disadvantageous for productivity and energy aspects. Therefore, the upper limit of the heat treatment time is preferably 10 hours or less, 3 hours or less, particularly 2 hours or less.

The crystallized glass obtained by the production method of the present invention, when having a thickness of 3 mm, has a transmittance at a wavelength of 700 nm of preferably 35% or less, more preferably 30% or less. Thus, the internal structure of a cooking device can be shielded sufficiently. On the other hand, when a temperature, a thermal power, or the like is displayed using an LED or the like, the transmittance at a wavelength of 700 nm of the glass having a thickness of 3 mm is preferably 15% or more, more desirably 18% or more. Thus, when the crystallized glass is used for a top plate of a cooking device, the display by an LED or the like can be recognized sufficiently through the crystallized glass.

Further, the crystallized glass of the present invention, when having a thickness of 3 mm, has a transmittance of preferably 85% or more, more preferably 86% or more at a wavelength of 1150 nm, in order to transmit heat rays (infrared rays) efficiently.

It is preferred that, even when the crystallized glass of the present invention is used for such application as a top plate for cooking device for a long period of time, the high infrared light transmittance be not impaired, and further, the visible light transmittance be hard to change. Specifically, it is preferred that the crystallized glass of the present invention has, in an acceleration test, a change amount of a transmittance of 5% or less, 3% or less, particularly 2% or less, at a thickness of 3 mm, at a wavelength of 1150 nm after heat treat treatment at 900° C. for 50 hours. Further, in the above acceleration test, it is preferred that a change amount of a transmittance at a wavelength of 700 nm be 5% or less, 3% or less, particularly 2% or less.

Further, the crystallized glass of the present invention preferably has an absorbance change ratio (calculated using the equation previously described) at a wavelength of 700 nm after the heat treatment at 900° C. for 50 hours of 20% or less, particularly 10% or less.

The thermal expansion coefficient of the crystallized glass of the present invention in a temperature range of 30 to 750° is preferably −10 to 30×10⁻⁷/° C., more preferably −10 to 20×10⁻⁷/° C. When the thermal expansion coefficient is within this range, glass excellent in thermal shock resistance is obtained.

The crystallized glass obtained by the production method of the present invention may be subjected to post-processing such as cutting, polishing, bending, and reheat pressing, and a surface thereof may be subjected to painting, film coating, or the like.

The crystallized glass thus produced can be used as a top plate for an IH cooking device equipped with an IH heater, a halogen heater cooking device equipped with a halogen heater, and a gas cooking device equipped with a gas burner.

### Example 2

Tables 4 and 5 show examples (Sample Nos. 15 to 19) and comparative examples (Sample Nos. 20 to 23) with respect to the second invention.

TABLE 4

| Mass % | | No. 15 | No. 16 | No. 17 | No. 18 | No. 19 |
|---|---|---|---|---|---|---|
| SiO₂ | | 67.93 | 66.35 | 68.34 | 68.9 | 69.1 |
| Al₂O₃ | | 21.0 | 22.0 | 21.5 | 20.0 | 20.5 |
| Li₂O | | 3.8 | 4.0 | 4.3 | 4.0 | 4.2 |
| Na₂O | | 0.4 | 0.2 | 0.1 | 0.3 | 0.4 |
| K₂O | | 0.3 | 0.3 | — | 0.2 | 0.3 |
| MgO | | 1.0 | 0.7 | 0.2 | 0.5 | 0.3 |
| ZnO | | 0.6 | 0.4 | 0.3 | 0.5 | — |
| TiO₂ | | 4.3 | 2.7 | 4.1 | 3.4 | 3.0 |
| ZrO₂ | | 0.5 | 2.0 | 0.7 | 1.2 | 1.5 |
| P₂O₅ | | — | 1.2 | — | 0.8 | 0.5 |
| SnO₂ | | 0.13 | 0.1 | 0.2 | 0.13 | 0.14 |
| V₂O₅ | | 0.04 | 0.05 | 0.06 | 0.07 | 0.06 |
| Cl | | — | — | 0.2 | — | — |
| Total | | 100 | 100 | 100 | 100 | 100 |
| Crystallization | Nucleus formation | 770° C. | 770° C. | 770° C. | 770° C. | 780° C. |
| step | | 30 | 30 | 30 | 30 | 30 |
| | | minutes | minutes | minutes | minutes | minutes |
| | Crystal growth | 870° C. | 870° C. | 870° C. | 870° C. | 870° C. |
| | | 25 | 25 | 25 | 25 | 25 |
| | | minutes | minutes | minutes | minutes | minutes |

| | | | | | | | |
|---|---|---|---|---|---|---|---|
| Transmittance | After | λ = 700 nm | 27.7 | 30.7 | 24.8 | 25.3 | 29.0 |
| (%) | crystallization | λ = 1150 nm | 87.2 | 86.3 | 85.8 | 84.8 | 86.1 |
| | After heat | λ = 700 nm | 27.1 | 24.3 | 23.8 | 21.7 | 24.1 |
| | treatment | λ = 1150 nm | 86.8 | 82.4 | 85.0 | 83.1 | 84.7 |

| | | | | | |
|---|---|---|---|---|---|
| Absorbance change ratio (%) | 2 | 17 | 3 | 10 | 13 |
| (λ = 700 nm) | | | | | |
| Devitrification | ∘ | ∘ | ∘ | ∘ | ∘ |

TABLE 5

| | | | [Mass %] | | | |
|---|---|---|---|---|---|---|
| | | | No. | No. | No. | No. |
| | | | 20 | 21 | 22 | 23 |
| SiO₂ | | | 69.1 | 69.1 | 66.6 | 65.5 |
| Al₂O₃ | | | 20.5 | 20.5 | 22.0 | 21.9 |
| Li₂O | | | 4.2 | 4.2 | 4.0 | 4.4 |
| Na₂O | | | 0.4 | 0.4 | 0.5 | 0.3 |
| K₂O | | | 0.3 | 0.3 | 0.3 | 0.3 |
| MgO | | | 0.3 | 0.3 | 1.0 | 0.8 |
| ZnO | | | — | — | 0.8 | 1.7 |
| TiO₂ | | | 3.0 | 3.0 | 2.4 | 4.3 |
| ZrO₂ | | | 1.5 | 1.5 | 2.2 | — |
| P₂O₅ | | | 0.5 | 0.5 | — | — |
| SnO₂ | | | 0.14 | 0.14 | 0.15 | — |
| V₂O₅ | | | 0.06 | 0.06 | 0.05 | 0.1 |
| As₂O₃ | | | — | — | — | 0.7 |
| Total | | | 100 | 100 | 100 | 100 |
| Crystal- | Nucleus formation | | 780° C. | 750° C. | 780° C. | 780° C. |
| lization | | | 5 min- | 30 min- | 30 min- | 30 min- |
| step | | | utes | utes | utes | utes |
| | Crystal growth | | 870° C. | 870° C. | 870° C. | 870° C. |
| | | | 25 min- | 25 min- | 25 min- | 25 min- |
| | | | utes | utes | utes | utes |
| | After | λ = 700 nm | 15.4* | 33.7 | 34.3 | 24.4 |
| Transmit- | crystal- | λ = 1150 nm | 73.5 | 86.4 | 86.5 | 84.2 |
| tance (%) | lization | | | | | |
| | After | λ = 700 nm | 12.3 | 25.3 | 23.2 | 12.3 |
| | heat | λ = 1150 nm | 69.3 | 84.7 | 81.7 | 80.2 |
| | treat- | | | | | |
| | ment | | | | | |

| | | | | |
|---|---|---|---|---|
| Absorbance change ratio (%) | 11 | 21 | 27 | 43 |
| (λ = 700 nm) | | | | |
| Devitrification | ∘ | ∘ | ∘ | ∘ |

Raw glass materials were blended so as to obtain the compositions described in Tables 4 and 5, and melted at 1600° C. for 20 hours, further at 1700° C. for 4 hours, using a platinum crucible. Two spacers each with a thickness of 5 mm were placed on a carbon plate, and molten glass was poured between the spacers and formed into a plate shape with a uniform thickness using a roller.

The resultant plate shaped sample was placed in an electric furnace kept at 700° C. and held for 30 minutes. After that, a power source was turned off to cool (anneal) the sample to room temperature in the furnace over 10 hours or more.

Then, the cooled sample was crystallized by heat treatment in the electric furnace to obtain crystallized glass. Tables 4 and 5 show the profile of heat treatment of each sample. A rate of temperature rise from room temperature to nucleus formation temperature was set to 15° C./min, a rate of temperature rise from the nucleus formation temperature to crystal growth temperature was set to 10° C./min, and a rate of temperature fall from the crystal growth temperature to the room temperature was set to 80° C./min.

Each crystallized glass was evaluated for its transmittance in each of visible and infrared regions and devitrification property.

Each crystallized glass was processed into a sample having a thickness of 3 mm with both surfaces which are mirror polished, and the transmittance thereof was measured at 700 nm and 1150 nm, using a spectrophotometer (manufactured by Jasco Corporation, V-760). The measurement conditions were as follows: a measurement range of 1500 to 380 nm and a scan speed of 200 nm/min. Further, the samples subjected to heat treatment at 900° C. for 50 hours (acceleration test) were also measured for transmittance similarly. Further, an absorbance change ratio after the acceleration test was calculated according to the equation described above.

The devitrification property was evaluated by placing each sample on a platinum foil in an electric furnace set to 1350° C., keeping the sample in that state for 24 hours, and determining whether or not devitrification occurred. If the devitrification was not observed, the evaluation was made as “o”, and if the devitrification was observed, the evaluation was made as “x”.

As is apparent from Tables 4 and 5, it is understood that the crystallized glass of each of Sample Nos. 15 to 19 as examples is capable of shielding light in the visible light region sufficiently, has high infrared light transmittance, and has small absorbance change ratio in the visible light region even in an acceleration test in which long-term use is assumed.

On the other hand, in the crystallized glass of each of Sample Nos. 21 to 23 as comparative examples, an absorbance change ratio in the visible region after the acceleration test was large. The external appearance of the crystallized glass of Sample No. 20 as a comparative example became white turbidity.

### INDUSTRIAL APPLICABILITY

The crystallized glass of the present invention is suitable as a top plate for a cooking device with, for example, gas, 1H, or a halogen heater. Further, the crystallized glass of the present invention can also be used for an inspection window for observing the inside of a high-temperature furnace, a fireproof window, and the like for each of which low-expansion crystallized glass containing a β-quartz solid solution as a main crystal has been used conventionally.

1. A crystallized glass, comprising, in terms of mass %, 55 to 73% of SiO₂, 17 to 25% of Al₂O₃, 2 to 5% of Li₂O, 4 to 5.5% of TiO₂, 0.05 to less than 0.2% of SnO₂, and 0.02 to 0.1% of V₂O₅, wherein the crystallized glass has a ratio V₂O₅/(SnO₂+V₂O₅) of 0.2 to 0.4 and is substantially free of As₂O₃ and Sb₂O₃.

2. A crystallized glass according to claim 1, further comprising 0.5% or less of Na₂O.

3. A crystallized glass according to claim 1, further comprising 0 to 2.3% of ZrO₂.

4. A crystallized glass according to claim 3, wherein a total amount of TiO₂ and ZrO₂ is 4 to 6.5%.

5. A crystallized glass according to claim 1, wherein the crystallized glass has a transmittance of 35% or less at a wavelength of 700 nm and a transmittance of 85% or more at a wavelength of 1150 nm when the crystallized glass has a thickness of 3 mm.

6. A top plate for cooking device, comprising the crystallized glass according to claim 1.

7. A method of producing crystallized glass, comprising the steps of: (1) blending raw material powder so as to comprise, in terms of mass %, 55 to 73% of SiO₂, 17 to 25% of Al₂O₃, 2 to 5% of Li₂O, 2.6 to 5.5% of TiO₂, 0.01 to 0.3% of SnO₂, and 0.02 to 0.2% of V₂O₅, and being substantially free of As₂O₃ and Sb₂O₃; (2) melting the raw material powder to produce precursor glass; and (3) heat-treating the precursor glass in a temperature range of 765 to 785° C. for at least 10 minutes to form crystal nuclei in the precursor glass.

8. A method of producing crystallized glass according to claim 7, further comprising the step of (4) heat-treating the precursor glass, in which the crystal nuclei have been formed, in a temperature range of 800 to 930° C. for at least 10 minutes to grow crystals.

9. A crystallized glass, which is produced by the method according to claim 7.

10. A crystallized glass according to claim 9, wherein the crystallized glass has an absorbance change ratio of 20% or less at a wavelength of 700 nm after heat treatment at 900° C. for 50 hours.

11. A top plate for cooking device, comprising the crystallized glass according to claim 9.

12. A crystallized glass according to claim 2, further comprising 0 to 2.3% of ZrO₂.

13. A crystallized glass, which is produced by the method according to claim 8.
